(19) United States
(12) Patent Application Publication
(10) Pub. No.: US 2011/0129101 A1
(43) Pub. Date: Jun. 2, 2011

(54) Directional Microphone

(75) Inventor: Anthony Hooley, Cambridge (GB)

(73) Assignee: 1...LIMITED, Cambridge (GB)

(21) Appl. No.: 11/632,440

(22) PCT Filed: Jul. 11, 2005
(86) PCT No.: PCT/GB05/02741

§ 371 Date: Aug. 14, 2007

(30) Foreign Application Priority Data
Jul. 13, 2004 (GB) 0415626.1

(51) Int. Cl. H04R 3/00

(52) U.S. Cl. 381/92

(57) ABSTRACT

A directional microphone system includes an ultrasonic emitter and receiver. The emitter directs a beam of ultrasound at the audio source with sufficient intensity that non-linear air effects cause non-linear interactions between the ultrasonic sound and the source's sonic sound. Ultrasonic frequency-mired sounds are thereby generated and these are received by the ultrasonic receiver. Signal-processing is carried out on the received signals to strip out the audio signals. The emitter and receiver may be co-located and the emitted beam may be focussed at the location of the audio source. The receiver may also be directional acid focussable. The directional microphone system may be very small and yet highly directional at sonic including low audible frequencies.

The present invention relates to a microphone and a method of receiving or detecting acoustic signals, particularly to a directional microphone for portable applications and devices.

### BACKGROUND OF THE INVENTION

Microphones, i.e. devices that convert sound-waves to electrical signals, are well known in the art. Directional forms of microphones are also known, the cardioid form being perhaps the best known, with a (wideband) directivity of 3 in theory. However, when much higher directivity is required then it is generally the case that the extent of the microphone has to be significantly greater than a wavelength of the lowest frequency where directionality is required. Thus, very directional microphones (e.g. D>>10) for low speech band frequencies, say 300 Hz, in air, tend to be large (>˜1 m in extent), and while this may be acceptable for some applications it is impractical for almost all portable applications. Thus the laws of physics dictate that highly directional low frequency microphones are large.

Parametric array loudspeakers are known in the art, wherein columns of ultrasound, generally radiated by a large-area (compared to wavelength scale) transducer or array of small transducer elements (the Transmitter), are caused to interact non-linearly with a surrounding fluid in which the sound propagates. If it is arranged that more than one ultrasonic frequency is radiated simultaneously from the Transmitter, at suitably high levels, then the fluid non-linearity causes mixing of the transmitted frequencies and sidebands to be created related to the sum and difference frequencies of the transmitted frequencies. Where the difference frequency(s) is below ˜20 kHz, audible sound may be generated in the fluid, though none was radiated by the Transmitter. It is necessary, for significant audible output level to be produced, for the ultrasonic levels to be high enough to make the fluid significantly non-linear, and ultrasonic SPLs of more than 100 dB are generally used, up to much higher levels.

It is an object of the present invention to provide a directional microphone, particularly a directional microphone suitable for portable applications and devices.

### SUMMARY OF THE INVENTION

The present invention shows how to overcome the large-size limitation of highly directional low-frequency microphones. The problem of directivity in the present invention is solved by shifting the frequencies up into a range where wavelengths get smaller, and thus microphones can also shrink and yet be highly directional.

The invention provide is a first aspect a directional microphone system for monitoring a source of acoustic signals in a low frequency range, the system comprising: one or more directional emitters of an acoustic ultrasonic frequency signal; one or more receivers for receiving acoustic signals in the ultrasonic frequency range, including signals at frequencies shifted by a frequency shift representing signals in the low frequency range as emitted by the source; and a signal processor to extract the signals in the low frequency range from the received signal.

The invention provides in a second aspect a method of receiving an acoustic source signal, said method comprising the steps of: (a) generating an ultrasonic acoustic signal of sufficient intensity to cause non-linear frequency mixing between said source signal and said ultrasonic acoustic signal; (b) receiving the signal caused by the non-linear frequency mixing; and (c) extracting the source signal from the received signal.

According to a first preferred embodiment of the invention a small but directional ultrasonic transmission antenna, UTA, (which may be unitary, or comprised of an array of small discrete transducers) emitting a beam of ultrasonic radiation, is directed at the source of (preferably sonic i.e. within the audible frequency range) sound to be captured by the directional microphone, so embedding the source in ultrasound at a high intensity, a process referred to herein as “ensonifying”. At sufficient intensity level, non-linear air effects will cause non-linear interactions between the ultrasonic sound and the source's sonic sound, resulting in frequency mixing within the medium of the (non-linear) air in the vicinity of the source, and in particular, sum and difference frequency band sounds will be generated, which themselves may be ultrasonic.

A sensitive ultrasonic receiver, UR, also comprising part of this preferred embodiment of the invention, preferably but not essentially located at or near the UTA, will detect the sum and/or difference frequency band sounds created in the vicinity of the Source, and these may be selectively filtered within the UR by signal processing means, including for example, non-linearly mixing or multiplying the UR's received signal with a sample of the ultrasonic input signal of the UTA, and then low-pass filtering to leave just the low frequency side bands. This is thus an active microphone or parametric microphone, active in the sense that the microphone actively emits energy and probes the space around it for sources of acoustic emission by stimulating non-linear effects in the surrounding fluid, and parametric in the same sense that a parametric array transmitter is.

As the level of coherent ultrasonic noise radiation (i.e. not associated with the source or the UTA) in the vicinity of the Directional Microphone (DM) will generally be low, it is thus inessential for the UR to itself be directional, as the only likely sound signals it is sensitive to will be those generated by non-linearity effects at the location of the source. It will thus be seen that such a system can be both small (the UTA need only be large compared to the ultrasonic wavelength transmitted, not the sonic wavelengths to be detected), and yet highly directional at sonic including low-audible frequencies.

A preferred embodiment thus includes a highly directional source of ultrasonic radiation; an ultrasonic radiation intensity at the Source sufficient to produce useful non-linearity effects in the air there; an ultrasonic receiver capable of detecting the non-linearity-generated ultrasonic sidebands at the Source; and a signal processing system capable of extracting the sonic information from the received ultrasonic sidebands.

The following lists preferred embodiments and variants of the present invention. Additional features may be added singly or in combination to this basic system to make it more versatile:

A) The UTA may be steerable, either mechanically, or, by implementing it with some form of electronically steerable phased-array. This enables a nominally fixed DM to selectively receive sonic signals from different, selectable, directions.

B) The UR may itself additionally be made directional, thus increasing the signal to noise ratio (SNR) and thus the directional selectivity of the DM. Again, this may be achieved by making the UR itself large, and mechanically steerable, or instead implementing it with some form of electronically steerable phased array. In either case, it is advantageous to ensure that the position in space to which the UR is most sensitive, tracks the position in space that the UTA is maximally ensonifying with ultrasonic energy.

C) The UTA may be focussable, such that its transmitted beam intensity is maximised at a small region in space at a certain nominal distance from the UTA (as opposed to focussed simply at infinity with nominally constant energy per unit length of beam (ignoring air absorption effects), particularly for example in the case when this small region is where the Source is located. This may be achieved either mechanically, by e.g. the use of a parabolic antenna, or by suitable signal processing of the signals to a phased array UTA. In this way, higher ultrasonic intensities may be achieved, at more localised regions of space, both increasing the sensitivity of the system, and the directivity, simultaneously.

D) In a similar manner, the UR may be made focussable, such that it is maximally selective to ultrasonic radiation from a small region of space and not simply a given direction. Typically this region would be the vicinity of the source. Again such focussing may be achieved mechanically or using phased-array techniques.

E) In certain circumstances it may be preferable to have the UR “tuned” to a narrow band of ultrasonic frequencies significantly different from the nominal transmission ultrasonic frequency of the UTA (e.g. to avoid saturation of a sensitive receiver). In this case, the UTA may be devised so as to transmit two or more ultrasonic frequencies simultaneously. Referring to these frequencies as Fu1 and Fu2, respectively, with Fu1>Fu2, they will when emitted at sufficient intensity non-linearly mix in the air and in so doing, will produce sum and difference frequencies Fs=Fu1+Fu2 and Fd=Fu1−Fu2, preferably such that both are ultrasonic to avoid unwanted sonic acoustic emission. All these ultrasonic signals, Fu1, Fu2, Fd and Fs, if of adequate level, will non-linearly mix with the sonic emissions of the source (in the vicinity of the Source) producing sidebands around these four frequencies, in which case the UR may be tuned to selectively receive one or other (or indeed both) of Fd and Fs and related sidebands, both of which may be chosen to be very different in frequency from the transmitted frequencies of the UTA. For example, if Fu1=70 kHz, Fu2=100 kHz, then Fd=30 kHz (still supersonic and inaudible) and Fs=170 kHz, high enough in frequency to easily filter out cleanly from Fu1 and Fu2. In this way, saturation of the UR may be completely avoided.

F) In situations where there is significant ultrasonic background noise to which the UR would generally be sensitive, further noise rejection may be achieved as follows: the ultrasound transmitted by the UTA may be a wideband (spread spectrum) signal instead of a single frequency signal. The UR is then made into a spread-spectrum receiver by using a suitably delayed (to compensate for the 2-way transit time between UTA to Source to UR) copy of the transmitted wide-band signal to multiply the UR's antenna signal. In this way, significant conversion gain can be achieved for the correlated, wanted, signal while uncorrelated background noise will be heavily rejected. This scheme also permits use of a DM in circumstances where it is desired to make its presence difficult to detect, as the wideband ultrasonic signal can be made to appear noise-like. Similarly, an unrelated UR, perhaps belonging to another DM in the vicinity, or perhaps part of an unrelated DM detection system operated by a third party, will not be able to so easily detect the presence of the DM, and in particular will not be able to easily decode the Source signals encoded in the ultrasonic sidebands, without first acquiring a phase-locked copy of the UTA transmitted wideband signal, necessary for correlated detection.

G) As the conversion of the source sound into ultrasonic sidebands is itself a non-linear process, the directly recovered base-band signals at the output of the UR will be a distorted copy of the original Source signal, primarily due to a square-law characteristic inherent in the non-linear process. It will usually be desirable to further signal process the UR output signal to compensate for this non-linearity, which is quite predictable.

H) A closed-loop DM system may be constructed by modulating the amplitude of the ultrasonic signals) transmitted by the UTA so as to counteract the received signal at the output of the UR, using a signal processed version of the UR output as a negative feedback UTA modulating signal. In this way, the form of the distortion reduction processing described in G) above can be altered, and in fact made into a simpler, more tractable computation. This is done by instead applying the distortion reduction process to a copy of the UTA modulating signal (itself derived from the UR output signal) and using this distortion-reduced form of the UTA modulating signal as the output of the DM. This method essentially uses a negative feedback loop to avoid the necessity of an explicit potentially multi-valued signal reconstruction task. As the frequency of the UTA ultrasonic signals will in general be much higher than those of the Source sounds to be detected, there will usually be adequate bandwidth in the UTA modulating system to adequately track the Source signals decoded by the UR. However, the loop delay time caused primarily by the acoustic signal path length (UTA to Source back to UR) unless very short will render this technique difficult or impossible. In this case, the feedback loop may be organised to arrange for the average amplitude of received signal to be approximately constant, by transmitting higher ultrasonic levels from the UTA when the Source amplitude is low, or further away, or both, so that e.g. a nearly constant SNR may be achieved.

I) Where the UTA is capable of steering its ultrasonic beam, the DM may be designed to track the position of a relatively moving Source, by steering the UTA ultrasonic beam to continuously follow the Source position. Where the UR is also steerable, that too can be steered to simultaneously track the Source location. The position-tracking control signals may either be derived by some distinct but interfaced Source-position tracking system (e.g. an IR sensor system could be used to track the open mouth of a human speaker, which will generally be warmer (i.e. more IR emitting) than the surroundings including the face of the speaker, or, an optical system), or instead, the DM itself may be used as the source of position-tracking control signals. One way to produce such tracking signals is to first automatically provide small-amplitude left-right and up-down (and in-out too, if a focussed beam is used) scanning signals (perhaps from one or more sawtooth or triangle oscillators or in software) to steer the UTA beam through small angles (and focus distances where appropriate) around the nominal target position, and by monitoring the correlated changes in received signal amplitude at the output of the UR, determining which new position better optimises the sensitivity of the DM. If these little scans are done continuously or semi-continuously, smooth tracking of the Source position can be achieved over wide angles and Source-DM distances.

J) It is possible in principle to use the same (or at least part of the same) physical antenna for both the function of UTA and UR. This is especially advantageous when this antenna is an electronically steerable phased-array antenna. In this case transmit/receive switching or directional coupler technology needs to be added to the antenna in standard ways to allow multiplexing of these two simultaneous functions.

K) The receiver signal processing system may be advantageously arranged to reject one of the generated sideband frequencies in any pair of upper and lower sidebands produced when the source signal Fs non-linearly interacts with the ultrasonic frequency Fu, so that either F1=Fu−Fs, or Fh=Fu+Fs is rejected, leaving only the remaining sideband. All the standard methods of making single-sideband (SSB) receivers are applicable here.

It will also be clear to those versed in the art that although the above description related to a DM operating in air, in practice any fluid capable of nonlinear behaviour at sufficiently high pressure levels could be substituted, so that, for example, a similarly compact DM system could be constructed for highly directional low-frequency sound reception in water, which could therefore be useful for detecting fish, shipping, underwater vessels, divers, oil rig components and systems, and more. Such similar other fluid-based systems are also part of the present invention.

For long range use in air, a limiting factor of the DM is the high attenuation in air of high-frequency ultrasonic signals (e.g. >>100 kHz). There is thus a practical upper limit to the UTA transmission frequency dependent on the desired range of reception. However, for close reception conditions, e.g. <=1 m, much higher frequencies than 100 kHz are also practical, for example 200 kHz and above and perhaps as high as 1 MHz.

The lower limit on UTA ultrasonic frequency is strictly governed by the required sonic bandwidth of the DM. For example, if it is desired to allow reception of sonic signals between say 20 Hz and 20 kHz then in order to avoid the lower ultrasonic sideband extending down to audible frequencies (which might cause unpleasant and certainly unwanted audible noise), then a lower UTA frequency of 40 kHz is needed, and 44-48 kHz will be a more practical lower limit.

### BRIEF DESCRIPTION OF THE DRAWINGS

FIG. 1 is a flow diagram illustrating the operation of the directional microphone;

FIG. 2 is a schematic representation of a directional microphone system operating at some distance from the audio source; and

FIG. 3 illustrates the use of a directional microphone of the invention in a mobile phone

### DETAILED DESCRIPTION AND EXAMPLES

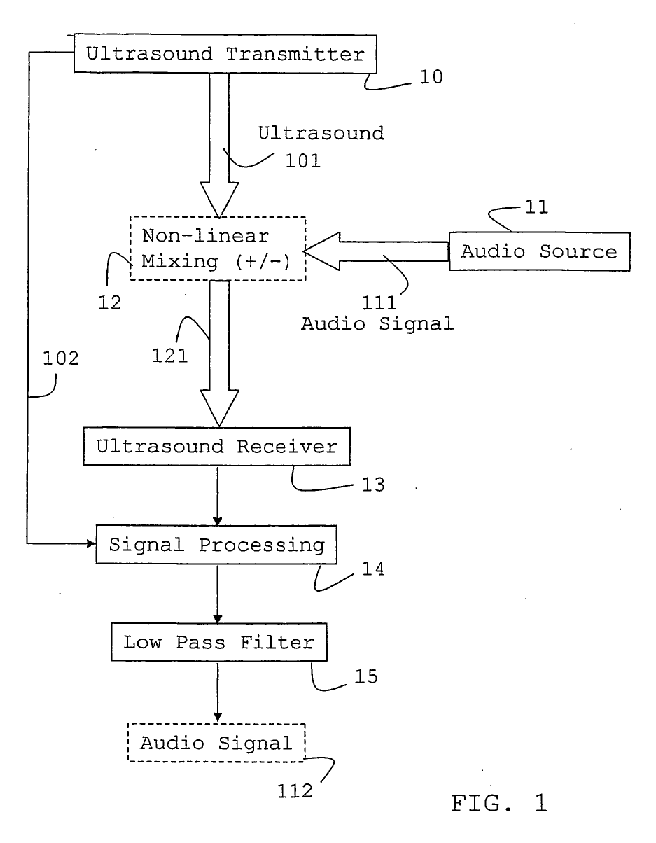

FIG. 1 is a flow diagram illustrating the operation of the directional microphone. The ultrasound transmitter 10 emits a beam of ultrasound, depicted by the double stemmed arrow 101, in the direction of the audio source 11 which may for example be a person speaking. The audible sound waves 111 emanating from the speaker's mouth interact nonlinearly in the air with the ultrasonic waves generating a source of further ultrasonic waves 121 with frequency modified by the audible signal. These generated [sum and difference] ultrasound waves radiate from the mixing point 12 and are picked up by an ultrasound receiver 13. The received signals are processed with reference to a signal 102 from the transmitter 10 using a signal processor 14 and filtered through a low-pass filter 15 to produce an audio signal 112, which is a representation of the original audio signal 111.

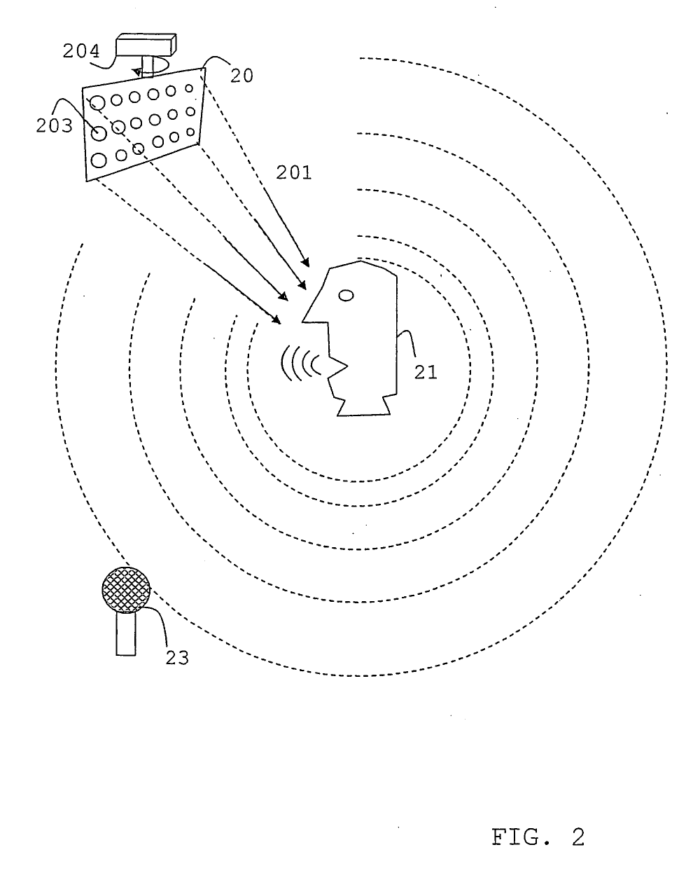

FIG. 2 is a schematic representation of a directional microphone system operating at some distance from the audio source. In this case, the audio source is a person 21 speaking who may be some tens of meters from the directional microphone. The directional microphone comprises an ultrasonic transmitter 20 and an ultrasonic receiver 23. Both the transmitter 20 and receiver 23 are antennae, the transmitter 20 comprising a plurality transducers 203 which convert electrical signals to mechanical movements at the desired ultrasound frequency while the receiver 23 conversely transduces the mechanical movements of the air into electrical signals. Ultrasound transmitters and receivers are well known in the art. The transmitter 20 emits a narrow beam of ultrasonic sound waves 201, depicted using dashed arrows.

Since the radiating area of the transmitter is very large compared to the wavelength of the ultrasound, the beam is highly directional and may even be focused to increase the intensity of the ultrasonic beam 201 at the location of the audio source 21. For example, a transmitter 300 mm in diameter emitting ultrasound at a frequency of 100 kHz has a radiating diameter about 100 times the wavelength, producing a tight parallel sided beam. The beam is emitted perpendicular to the face of the transmitter and its direction can therefore be selected by angling the transmitter. In the system of FIG. 2 this is effected by a servo mechanism 204 but equally this could be under manual operator control. The ultrasound beam ensonifies the audio source 21, that is the mouth of the person speaking. As the audio speech waves emanate from the speaker they mix nonlinearly in the air with the ultrasonic waves, generating new ultrasonic waves with frequencies modulated by the sound waves. This generated ultrasound radiates from the mixing zone outside the speaker's mouth, depicted in FIG. 2 as dashed omnidirectional wavefronts. The radiated ultrasound is received by the ultrasound receiver 23, where the signals are processed to strip the audio signal out of the ultrasonic carrier wave. Since the original ultrasonic beam 201 is very narrow and directional, the received signal is from a tightly specified area only. Even though the mixed signal is omnidirectional, its source is limited to the volume in which the beam 201 is present in sufficiently high intensity so as to cause non-linear effects. The combination of high intensity narrow beam with the receiver thus provides a highly directional microphone, even when receiving very low (long wavelength) audio input frequencies.

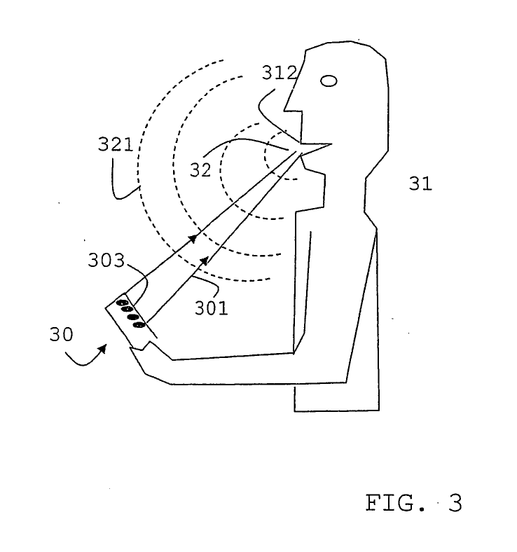

FIG. 3 illustrates the use of a directional microphone of the invention in a mobile phone. The mobile phone 30 incorporates an ultrasonic transducer array 303 acting as both the transmitter and receiver of the directional microphone, or alternatively comprising a transmitting section and a receiving section. The transducer array 303 is shown on the front face of the mobile phone 30, where it fits around other components such as a display screen and keyboard. The transducer array is arranged to be operable as a phased array such that the emitted beam may be directed and focussed. Such phased arrays are well known in the art, for example in ultrasonic crack detection systems. In use, the transducer array 303 emits a beam of ultrasound 301 towards the mouth 312 of the user 31. The beam is focussed at a focal point 32 in the vicinity of the user's mouth. As the user speaks, the sound waves 321 emanating from the user's mouth interact nonlinearly with the high intensity ultrasonic waves at the focal point 32, mixing to generate radiated waves of modulated frequency, predominantly the ultrasonic frequency plus and minus the speech frequencies. The generated (mixed) waves radiate outwards from the focal point 32, including back towards the transducer array 303, together with waves first reflected off the mouth and face of user 31. These generated waves are received at the array 303 and converted by the transducers into electrical signals. The signals are processed in a processor (not shown) to strip out the audio content.

In a simpler variant of the directional microphone of FIG. 3, the transducer array is not a phased array but a fixed focus, fixed direction emitter. An array which is appropriately curved or dished, for example into a spherical, elliptical or parabolic shape, emits a beam which has a focus. For the mobile phone application, the focal length is chosen as the typical hand-to-mouth distance for a hands-free mobile phone user, which is about 40 cm. Such a fixed focus array is simpler to implement than a phased array since the phased array driving electronics are not required. Fixed focus can also be implemented in a flat array by applying a pattern of delays to the signals emitted by the transducers in the array; typically the signals from the central transducers are delayed relative to those of the outer transducers. Again, this is cheaper to implement than a full phased array. However, in the variant shown in FIG. 3, the emitter is a full phased array and the focal distance and beam direction can be varied in operation. This allows control of the focal point to optimise reception of the audio signal, thereby improving signal to noise ratio. Optimisation may be carried out by scanning the beam around, or by using the mobile phone's built-in camera (where fitted) to optically detect the position of the user's mouth, or under user control.

One particular close-range application of the DM is a directional audio-frequency microphone for a portable telephone. In the case where such a telephone contains a video screen that the telephone user may want to look at, it is impractical to simultaneously have the telephone (if small) close to the mouth of the user. In high-noise environments, such as railway stations, bars and airport lounges, a non-directional or even cardioid style microphone will unselectively receive the user's voice together with a high level of unwanted noise, making intelligibility poor. A DM applied to this situation can highly selectively receive just from the vicinity of the user's mouth, eliminating most of the background noise.

Consider a typical cell-phone, ˜100 mm long and ˜35 mm wide. At 300 Hz (a typical low frequency present in a male human voice), the wavelength in air is ˜1.1 m, and even the longest dimension of the cellphone (if all of it were used as a sonic microphone) is as small as ˜ 1/10th of a wavelength, and extremely poor directional performance could be achieved at this frequency using purely linear, sonic microphone techniques—perhaps the best one could do would be to use a cardioid microphone for a directivity <=˜3.

Use of a DM with an ultrasonic frequency of ˜150 kHz e.g., where the wavelength is ˜2.2 mm provides very much greater directivity, assuming again that a DM microphone can be made as large as the phone face. Even reducing this to, e.g. a small array about the size of the phone width, ˜35 mm, still provides an array ˜16 wavelengths across. Typical directivities achievable for such DMs are 35 and 13 respectively, a great improvement over cardioid mics, and enough to significantly improve SNR. Frequencies as high as 150 kHz are practical in such short range applications, typically 0.3 to 0.4 m for a hand-held telephone, as the attenuation of the ultrasonic waves due to the air is still less than 2.2 dB for a round trip (DM to Source back to DM) in dry air. Higher frequencies still are thus quite possible from this perspective.

The level of a normal human speaking voice is ˜64 dBA at 1 m. The magnitude of the non-linear sidebands created by interaction of the sonic waveform (from the Source, in this case the human telephone user) with the ultrasonic waveform is proportional to the square of the amplitude of both signals. While 64 dBA is a low-level signal compared to the typical levels used in parametric loudspeakers, this is the level at lm from the speaker's mouth. At the mouth itself the level will be considerably higher, typically more than 84 dBA. With a tracking focussed UTA beam centred on the mouth of the speaker, ultrasonic SPLs in the 110-130 dB region are quite practical which produce sideband levels sufficiently above background to be readily detectable. For even better SNR a spread spectrum scheme as described previously may beneficially be implemented.

1-32. (canceled)

33. Directional microphone system for monitoring a source of acoustic signals in a low frequency range, the system comprising:
one or more directional emitters of an acoustic ultrasonic frequency signal;
one or more receivers for receiving acoustic signals in the ultrasonic frequency range, including signals at frequencies shifted by a frequency shift representing signals in the low frequency range as emitted by the source; and
a signal processor to extract the signals in the low frequency range from the received signal.

34. The microphone system of claim 33, wherein the directional emitter has sufficient power to cause non-linear acoustical frequency mixing in a fluid medium surrounding the source.

35. The microphone system of claim 33, wherein the directional emitter is steerable

36. The microphone system of claim 35, further comprising a tracking system to lock the direction of the directional emitter on to the moving source.

37. The microphone system of claim 36, wherein the receiver is directional and further comprising a tracking system to lock the direction of the receiver on to the moving source.

38. The microphone system of claim 33, wherein the directional emitter comprises an array of transducers.

39. The microphone system of claim 33, wherein the directional emitter is focusable so as to be capable of generating a localized volume of acoustic ultrasound signals of high intensity.

40. The microphone system of claim 33, wherein the receiver is a directional receiver.

41. The microphone system of claim 40, wherein the directional receiver comprises an array of transducers.

42. The microphone system of claim 41, wherein the directional receiver is focusable on or near the source.

43. The microphone system of claim 33, wherein the one or more directional emitters emit at least two ultrasonic frequency signals such that the difference in frequency between said two ultrasonic frequency signals is higher than an audible frequency range.

44. The microphone system of claim 33, wherein the receiver correlates phase-locked acoustic signals of the emitter with the received acoustic signals to extract the signals in the low frequency range.

45. The microphone system of claim 33, wherein the signal processor uses signal processing parameters derived from a comparison of the undistorted emitted acoustic ultrasonic signals and the received acoustic ultrasonic signals.

46. The microphone system of claim 33, wherein emitter and receiver are co-located.

47. The microphone system of claim 46, wherein emitter and receiver comprise identical transducers.

48. The microphone system of claim 33, wherein the low frequency range is the audible frequency range.

49. The microphone system of claim 33, wherein the low frequency range to be monitored is the 20 Hz-20 kHz.

50. The microphone system of claim 49, wherein the lower limit of the ultrasonic frequency range is 40 kHz.

51. The microphone system of claim 33, wherein the upper limit of the ultrasonic frequency range is 100 kHz.

52. The microphone system of claim 50, wherein the upper limit of the ultrasonic frequency range is 1 MHz.

53. The microphone system of claim 33, wherein the signal processor suppresses signals in one sideband.

54. The microphone system of claim 33, wherein the signal processor compensates the recovered audio for the non-linearities inherent in the non-linear mixing process.

55. A method of receiving an acoustic source signal, said method comprising the steps of:
(a) generating an ultrasonic acoustic signal in a directional beam of sufficient intensity to cause non-linear frequency mixing between said source signal and said ultrasonic acoustic signal;
(b) receiving the signal caused by the non-linear frequency mixing; and
(c) extracting the source signal from the received signal.

56. A method according to claim 55, wherein the mixed signal is received by a direction-sensitive receiver.

57. A method according to claim 55, wherein said ultrasonic acoustic signal is generated by a phased array of ultrasonic transducers.

58. A method according to claim 55, wherein said non-linear frequency mixing results in sum and difference ultrasonic signals having a frequency representing the sum of the frequency of the generated ultrasonic signal and the frequency of the acoustic source signal and the difference between the frequency of the generated ultrasonic signal and the frequency of the acoustic source signal respectively.

59. A method according to claim 55, wherein said ultrasonic signal is generated in the range of 40 kHz to 200 kHz and said received signal is in the range of 20 kHz and 220 kHz.

60. A method according to claim 59, wherein said generated ultrasonic signal is about 100 kHz and said received signal is in the range of 75 kHz to 125 kHz.

61. Portable device comprising a microphone system in accordance with claim 33.

62. The portable device of claim 61, wherein the portable device is a mobile telephone.

63. Portable device comprising a microphone system which uses the method of claim 55.
